(19) United States
(12) Patent Application Publication
(10) Pub. No.: US 2001/0030790 A1
(43) Pub. Date: Oct. 18, 2001

(54) Optical fiber transmission line and optical transmission system

(76) Inventor: Rintaro Kurebayashi, Tokyo (JP)

Correspondence Address: McGinn & Gibb, PLLC, 8321 Old Courthouse Road, Suite 200, Vienna, VA, 22182-3817, US

(21) Appl. No.: 09/829,948

(22) Filed: Apr. 11, 2001

(30) Foreign Application Priority Data
Apr. 13, 2000 (JP) 117180/2000

(51) Int. Cl. H04B 10/00; H04B 10/12

(52) U.S. Cl. 359/161; 359/173

(57) ABSTRACT

An optical transmission system includes an optical fiber transmission line having a single mode optical fiber and a dispersion compensating fiber. When alight source installed at an optical receiving station transmits pumping light with a wavelength ranging from 1.42 μ to 1.48 μ to the dispersion compensating fiber, the dispersion compensating fiber amplifies signal light according to Raman amplifying effect. Accordingly, the non-repeating optical fiber transmission line can be elongated. The optical fiber transmission line can include an erbium doped optical fiber. In this case, a non-repeating section can be further elongated.

### BACKGROUND OF THE INVENTION

1. Field of the Invention

This invention relates to an optical fiber transmission line and an optical transmission system and particularly to the non-repeating optical fiber transmission line and non-repeating optical transmission system.

2. Description of the Related Prior Art

Various systems for non-repeating optical transmission have been proposed heretofore. In the system, it is not necessary to provide an optical repeater in a transmission line, so that the cost can be reduced. For example, in ECOC' 99, proposed is an optical fiber transmission line in which an erbium doped optical fiber (EDF) and a single mode optical fiber (SMF) are alternately cascaded-connected. Mainly the EDF amplifies a wavelength division multiplexing optical signal with 10 Gbit/s-32 ch. A receiving station is provided with a dispersion compensating fiber (DCF), thereby compensating for dispersion stored in the optical fiber transmission line. This optical fiber transmission line, however, requires two optical fibers, that is, an optical fiber for transmitting pumping light to the vicinity of the EDF and an optical fiber for an optical signal. Accordingly, an increase in cost is inevitable. Further, since the receiving station compensates for dispersion, the equipment of the receiving station becomes large-sized. The longer the optical fiber is, the more the large-scale receiving station equipment is required. As some other known examples, Japanese Patent Laid-Open Hei 8-204634 discloses a system in which the gain of an optical signal to a dispersion compensating fiber is controlled by an attenuator, Japanese Patent Laid-Open Hei 9-230399 and Japanese Patent Laid-Open Hei 10-200509 disclose a non-repeating system in which the power of an optical signal is increased.

### SUMMARY OF THE INVENTION

The present invention has been made in view of the above circumstances and provides an optical fiber transmission line which costs low and has high-efficiency, and an optical fiber transmission system which may reduce the size of an optical receiving station.

According to an aspect of the present invention, the optical fiber transmission line includes an optical fiber to which a dispersion compensating optical fiber is cascaded-connected as a part of the optical fiber transmission line. The dispersion compensating optical fiber is set to have a length for compensating for dispersion of the optical fiber transmission line. The optical fiber transmission line may include a single mode optical fiber, and further may include a rare-earth doped optical fiber. According to another aspect of the invention, the optical fiber transmission system includes an optical fiber transmission line in which a single mode optical fiber and a dispersion compensating optical fiber are cascaded-connected, and a light source disposed at the subsequent stage of the dispersion compensating fiber for transmitting pumping light to the dispersion compensating fiber. The dispersion compensating fiber is adapted to amplify an optical signal by the pumping light. According to another aspect of the invention, the optical fiber transmission system includes a light source for transmitting pumping light, which is installed at a receiving station. The optical fiber transmission line may include a rare-earth doped optical fiber. In this case, the rare-earth doped optical fiber is capable of amplifying an optical signal by the pumping light. The above constitution may effect a low-cost and high-efficiency non-repeating optical fiber transmission line.

### BRIEF DESCRIPTION OF THE DRAWINGS

The above and other objects, features and advantages of the present invention will become apparent from the following detailed description when taken with the accompanying drawings in which:

FIG. 1 is a block diagram of the conventional non-repeating optical fiber transmission system;

FIG. 2 is a block diagram of a non-repeating optical fiber transmission system according to an embodiment of the invention;

FIG. 3 is a graph showing the relationship between the power of an optical signal and the transmission distance; and

FIG. 4 is a block diagram of a non-repeating optical fiber transmission system according to another embodiment of the invention.

### DETAILED DESCRIPTION OF THE PREFERRED EMBODIMENTS

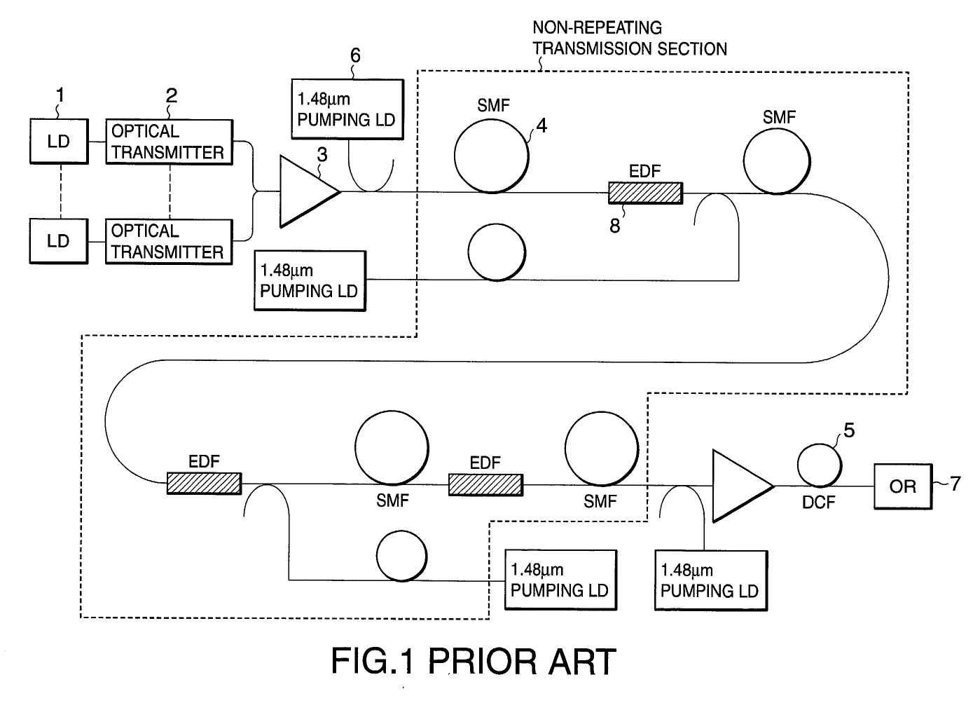

FIG. 1 shows the conventional non-repeating optical fiber transmission system. A portion enclosed with a broken line in FIG. 1 corresponds to a non-repeating optical fiber transmission line. In the transmission line, a single mode fiber (SMF) 4 and an erbium doped optical fiber (EDF) 8 are alternately cascaded-connected. Further, disposed is an optical fiber transmission line for introducing pumping light with a wavelength of 1.48μ transmitted from an optically pumped laser diode 6 installed outside the transmission line to the vicinity of the EDF. An optical signal transmitted through an LD 1 and an optical transmitter 2 of a transmitting station is amplified by an optical amplifier 3 in the transmitting station, and then sent to a non-repeating optical fiber transmission line. The optical signal is compensated for its dispersion by a dispersion compensating fiber (DCF) 5, and received by an optical receiver (OR) 7. In this optical fiber transmission system, the non-repeating optical transmission line requires two types of optical fibers, resulting in increasing the cost, and since the optical receiving station is provided with a dispersion compensating optical fiber, it is difficult to reduce the size of the station.

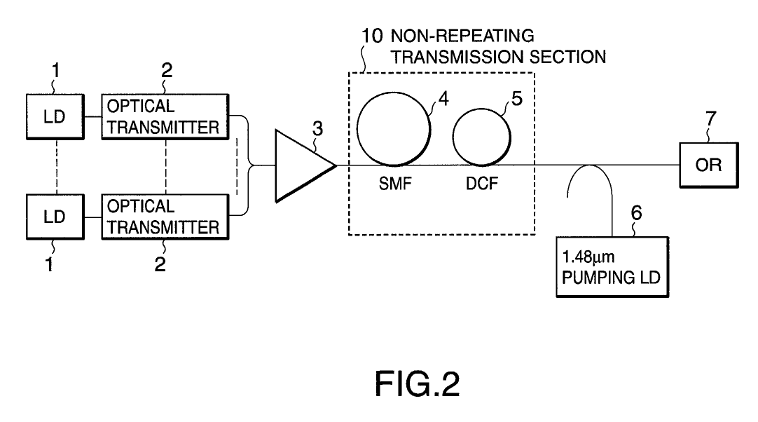

Referring to FIG. 2, the optical fiber transmission system of an embodiment of the invention includes a non-repeating optical fiber transmission line in which a single mode optical fiber and a dispersion compensating optical fiber are cascaded-connected. As the single mode fiber, for example, used is a pure silica core fiber having a positive dispersion value. The pure silica core fiber has a larger effective area as compared with the optical fiber used in the other optical communication. Therefore, the fiber is hardly influenced by nonlinear optical characteristic and transmission loss is small, so that the transmission distance can be enlarged. The optical signal which is transmitted through a LD 1 and an optical transmitter 2 of the optical transmitting station and subjected to wavelength multiplexing, is amplified by an optical amplifier 3, and then transmitted to an optical fiber transmission line. The greater power of the optical signal will be desirable. As the power of the optical signal becomes greater, however, the waveform deterioration is caused by the nonlinear optical characteristic of the optical fiber. Therefore, the output power of the optical signal is set within a designated range. At the subsequent stage of the optical transmission line, disposed is an LD 6 capable of outputting pumping light ranging from 1.42μ band to 1.48μ band. A DCF 5 is desirably disposed on the optical receiving station side in the optical transmission line, so the LD 6 is desirably installed at the optical receiving station. The LD 6 outputs pumping light in the direction reverse to the optical signal. The dispersion compensating fiber (DCF) which has received the pumping light amplifies an optical signal according to Raman amplifying effect. The Raman amplifying effect is inversely proportion to the effective sectional area of the optical fiber. Generally, the effective sectional area of the dispersion compensating fiber is much smaller than those of the other optical fibers, so that Raman amplification is performed at high efficiency. The dispersion compensating fiber has a negative dispersion value, and is set to have a length for compensating for dispersion of the optical fiber transmission line.

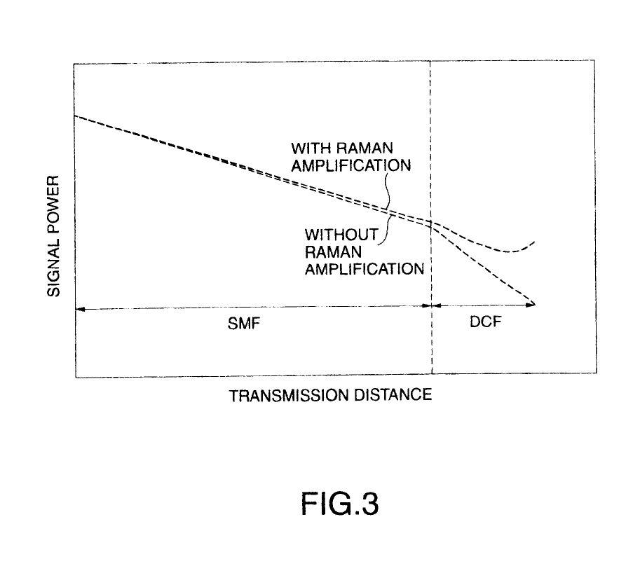

FIG. 3 shows the relationship between the transmission distance of an optical signal in the optical fiber transmission line and the power of an optical signal. While the optical signal is propagated in the single mode optical fiber (SMF), the power is monotonously lowered. The optical signal, however, is amplified by the dispersion compensating optical fiber which has received pumping light, so that the power is kept from being further lowered.

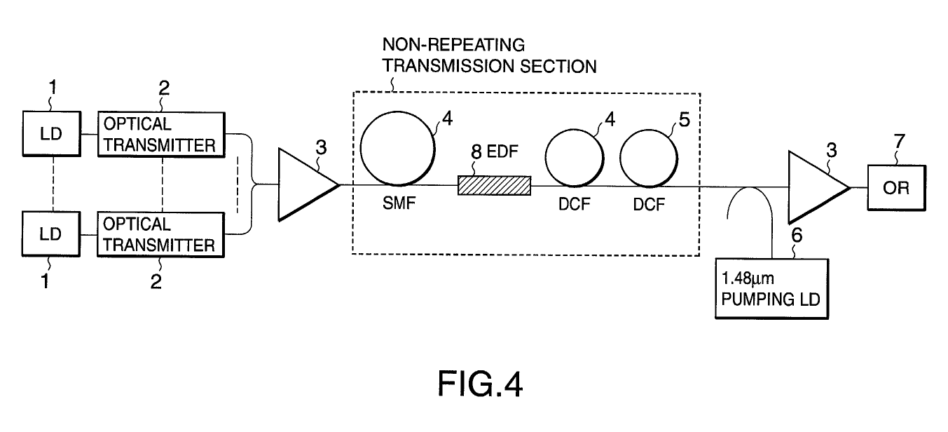

FIG. 4 shows a second embodiment of an optical fiber transmission system according to the invention. According to this embodiment, in the non-repeating optical fiber transmission line, an erbium doped optical fiber (EDF) 8 is arranged between single mode optical fibers (SMF) 4, and at the subsequent stage of these optical fibers, disposed is a dispersion compensating fiber (DCF) 5. At the subsequent stage of the optical fiber transmission line, disposed is an LD 6 for outputting pumping light with 1.48μ in the direction reverse to the optical signal. When the pumping light is transmitted to the dispersion compensating fiber (DCF) 5 and the erbium doped optical fiber (EDF) 8, these fibers amplify an optical signal. Accordingly, a transmission line further longer than the optical fiber transmission line shown in FIG. 2 may be formed. The pumping light is used also for optical amplification in the erbium doped optical fiber (EDF) 8, so the wavelength is 1.48μ. Further, plural sets of SMF 4, EDF 8 and SMF 4 may be cascaded-connected.

In the optical fiber transmission system of the invention, the non-repeating optical fiber transmission line may be made longer, and formed at a lower cost. Furthermore, since the optical receiving station is not provided with the dispersion compensating fiber (DCF), the station may be reduced in size. Particularly, The invention is effective for high bit rate transmission(e.g. WDM of 40 Gb/s).

While the present invention has been described in connection with certain preferred embodiments, it is to be understood that the subject matter encompassed by the present invention is not limited to those specific embodiments. On the contrary, it is intended to include all alternatives, modifications, and equivalents as can be included within the spirit and scope of the following claims.

What is claimed is:

1. An optical fiber transmission line, in which an optical signal is transmitted, including an optical fiber to which a dispersion compensating optical fiber is cascaded-connected as a part of an optical fiber transmission line, wherein the dispersion compensating optical fiber is set to have a length for compensating for dispersion of the optical fiber transmission line.

2. An optical fiber transmission line, in which an optical signal is transmitted, including an optical fiber in which a single mode optical fiber and a dispersion compensating optical fiber are cascaded-connected, wherein the dispersion compensating optical fiber is set to have a length for compensating for dispersion of the optical fiber transmission line.

3. The optical fiber transmission line according to claim 2, wherein further a rare-earth doped optical fiber is cascaded-connected.

4. The optical fiber transmission line according to claim 2, wherein a rare-earth doped optical fiber is cascaded-connected between the single mode optical fibers.

5. The optical fiber transmission line according to claim 2, wherein the single mode optical fiber is a pure silica core fiber.

6. An optical transmission system for transmitting an optical signal, including:
an optical fiber transmission line in which a single mode optical fiber and a dispersion compensating optical fiber are cascaded-connected; and
a light source for disposed at the subsequent stage of the dispersion compensating fiber to transmit pumping light to the dispersion compensating fiber,
wherein the dispersion compensating fiber amplifies an optical signal by the pumping light.

7. An optical transmission system for transmitting an optical signal, including:
an optical fiber transmission line in which a single mode optical fiber and a dispersion compensating optical fiber are cascaded-connected; and
a light source disposed at an optical receiving station for transmitting pumping light to the dispersion compensating fiber,
wherein the dispersion compensating fiber amplifies an optical signal by the pumping light.

8. The optical transmission system according to claim 7, wherein the system includes: an optical fiber transmission line in which a single mode optical fiber, a rare-earth doped optical fiber and a dispersion compensating optical fiber are cascaded-connected; and a light source disposed at an optical receiving station to transmit pumping light to the dispersion compensating fiber, and the dispersion compensating fiber and the rare-earth doped optical fiber amplify an optical fiber by the pumping light.

9. The optical transmission system according to claim 7, wherein the dispersion compensating optical fiber is set to have a length for compensating for dispersion of an optical fiber transmission line.

10. The optical transmission system according to claim 7, wherein the wavelength of pumping light ranges from 1.42μ band to 1.48μ band.

11. The optical transmission system according to claim 7, wherein the wavelength of pumping light is 1.48μ band.
